(19) United States
(12) Patent Application Publication
(10) Pub. No.: US 2016/0252033 A1
(43) Pub. Date: Sep. 1, 2016

(54) CYLINDER CUTOUT STRATEGY FOR OPERATION OF ENGINE

(71) Applicant: Caterpillar Inc., Peoria, IL (US)

(72) Inventors: Adam D. Dye, Peoria, IL (US); Andy Publes, Washington, IL (US); Arthur L. Gilliam, Peoria, IL (US); Dustin K. Fee, Peoria, IL (US); Kirti C. Tamhane, Dunlap, IL (US)

(73) Assignee: Caterpillar Inc., Peoria, IL (US)

(21) Appl. No.: 15/149,290

(22) Filed: May 9, 2016

(51) Int. Cl. F02D 41/14; F02D 41/40; F02D 17/02; F02D 41/30

(52) U.S. Cl. CPC F02D 41/1497; F02D 41/3005; F02D 41/401; F02D 17/02; F02D 2200/101

(57) ABSTRACT

The disclosure provides a method to operate an engine including a first set of cylinders and a second set of cylinders with the help of an engine control module (ECM). The ECM determines a current engine speed, a current engine load, and a current degree of rotation. If the current engine load is below a threshold load that corresponds to the current engine speed, the ECM selects a cylinder cutout strategy. The ECM initiates the cylinder cutout strategy wherein the fuel supply is cutout alternatively between the first set of cylinders and the second set of cylinders at a predetermined degree of rotation. The fuel injection is modified by a predetermined amount to a set of non-cutout cylinders. The ECM deactivates the cylinder cutout strategy when the current engine load exceeds the threshold load that corresponds to the current engine speed.

### TECHNICAL FIELD

The present disclosure generally relates to an internal combustion engine. More specifically, the present disclosure relates to a cylinder cutout strategy to prevent unstable operation without uneven wear of the engine.

### BACKGROUND

Engines, such as diesel-powered engines rely on heat of compression to ignite an air/fuel mixture in engine cylinders. The engines may be equipped with Mechanically actuated Electronically controlled Unit Injector (MEUI) fuel systems. For a high power density engine, MEUI systems typically require high injector steady flow and fast camshafts. High flow injector/camshaft combination of the MEUI fuel system is unable to deliver consistent small quantities of fuel required at an idle or low load conditions. This may result in instability of engine speeds due to the injectors operating at a highly nonlinear part of delivery curve at such loads. Consequently, the engine governor starts hunting, which causes the engines fueling, and therefore oscillations in power delivery. In such instances, the engine speed will oscillate due to non-uniform power delivery, and in extreme cases some of the engine cylinders will fire while the others do not. When the engine cylinders misfire, a popping sound may be generated and the unburnt fuel mixture may expel through an exhaust system in a vaporized form generically referred to as “white smoke”. Smooth engine speed is desirable by the consumer and the reduction of white smoke is desirable, due in part, to the ever-increasing consumer and governmental requirements for fuel economy, performance, and emissions. Hence, it would be preferable to cause the engine to operate under more linear portions of operating curves to reduce these fluctuations.

Typically, a cylinder cutout method is used for reducing or completely stopping combustion within one or more engine cylinders, to achieve engine stabilization. For example, the cylinder cutout method is a widely followed practice to periodically cutout one or more engine cylinders for a brief period of time to monitor resultant engine operating conditions and thus determine if the engine cylinders and associated components are functioning within acceptable limits. However the use of cylinder cutout method may cause excessive noise and vibration within the engine due to an imbalance of torsional loads, on the engine. Further, the cylinder cutout method allows non-cut cylinders to work more than cutout cylinders, which may lead to uneven cylinder-to-cylinder wear.

United States Application Number 2014/0090624 discloses a method and a system to control firing sequence of the engine to reduce vibrations. Although, the reference solves the problem of vibration balance and includes a variable pattern, the fuel quantity is not altered based on power requirements.

The presently disclosed system is directed to overcoming one or more of the problems set forth above.

### SUMMARY OF THE DISCLOSURE

The disclosure provides a method of operation of an engine. The engine includes a plurality of cylinders divided into a first set of cylinders and a second set of cylinders. The method starts with determination of a current engine speed and a current engine load via an engine control module (ECM). The ECM determines a current degree of rotation measured via a crank position sensor. If the current engine load is below a threshold load that corresponds to the current engine speed, the ECM selects a cylinder cutout strategy. The ECM initiates the cylinder cutout strategy such that the fuel supply is cutout alternatively between the first set of cylinders and the second set of cylinders upon detection that the current degree of rotation corresponds to a predetermined degree of rotation. The fuel injection is modified by a predetermined amount to a set of non-cutout cylinders until deactivation of the cylinder cutout strategy. The ECM deactivates the cylinder cutout strategy when the current engine load exceeds the threshold load that corresponds to the current engine speed.

### BRIEF DESCRIPTION OF THE DRAWING

FIG. 1 is a schematic of an engine system including an engine and a cylinder cutout system, in accordance with the concepts of the present disclosure; and

FIG. 2A-2B is a flow chart for a method to operate the engine using a cylinder cutout strategy, in accordance with the concepts of the present disclosure.

### DETAILED DESCRIPTION

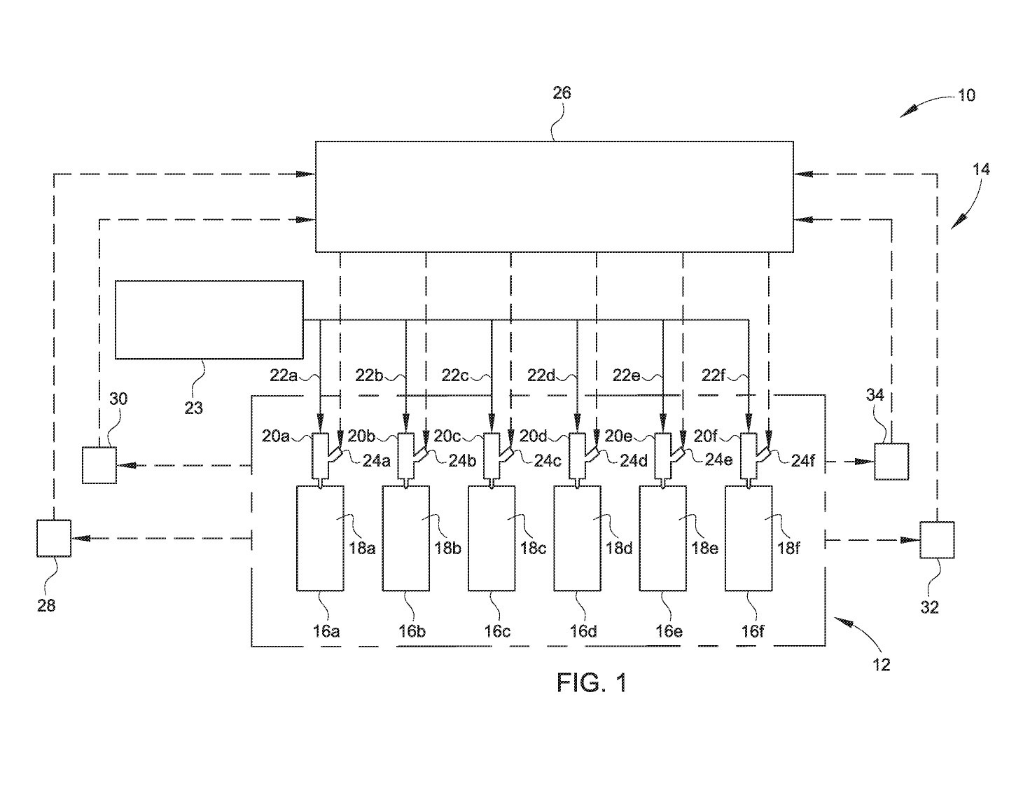

Referring to FIG. 1, there is shown an engine system 10, which includes an engine 12 and a cylinder cutout system 14. The engine 12 includes various components for the purpose of combustion and production of power. The engine 12 includes cylinders 16a, 16b, 16c, 16d, 16e, and 16f. For example, FIG. 1 shows six cylinders 16a, 16b, 16c, 16d, 16e, and 16f. However, any number of cylinders more than one may be used. For example, the engine 12 may include eight, ten, twelve, or some other number of cylinders.

Each of the cylinders 16a, 16b, 16c, 16d, 16e, and 16f, includes a corresponding combustion chamber 18a, 18b, 18c, 18d, 18e, and 18f and a piston (not shown). The combustion chambers 18a, 18b, 18c, 18d, 18e, and 18f are structured to allow combustion of fuel and air to produce power.

The piston (not shown) may be disposed in the cylinders 16a, 16b, 16c, 16d, 16e, and 16f, so as to reciprocate between a top dead center (TDC) position and a bottom dead center (BDC) position during an intake stroke, a compression stroke, a combustion or power stroke, and an exhaust stroke. The piston (not shown) may be operatively connected to a crankshaft (not shown) in a manner well known in the art.

Each of the six cylinders 16a, 16b, 16c, 16d, 16e, and 16f is associated with a corresponding one of six fuel injectors 20a, 20b, 20c, 20d, 20e, and 20f. Each of the six fuel injectors 20a, 20b, 20c, 20d, 20e, and 20f may receive fuel from a corresponding fuel injector supply line 22a, 22b, 22c, 22d, 22e, and 22f, which in turn may receive fuel from a fuel source 23. It is well known in the art that additional components, such as, pumps, filters, and the like may also be included to supply fuel to the fuel injectors 20a, 20b, 20c, 20d, 20e, and 20f. The fuel injectors 20a, 20b, 20c, 20d, 20e, and 20f are disposed within cylinder heads (not shown) of the respective cylinders 16a, 16b, 16c, 16d, 16e, and 16f are connected to inject fuel into combustion chambers 18a, 18b, 18c, 18d, 18e, and 18f The fuel injectors 20a, 20b, 20c, 20d, 20e, and 20f may embody, for example, electronically actuated-electronically controlled unit injectors, mechanically actuated-electronically controlled injectors, digitally controlled fuel valves, or other type of fuel injectors known in the art. The fuel injectors 20a, 20b, 20c, 20d, 20e, and 20f are in control communication to corresponding control solenoids 24a, 24b, 24c, 24e, and 24f. Each of the fuel injectors 20a, 20b, 20c, 20d, 20e, and 20f may be separately and independently operable to inject a predetermined amount of pressurized fuel into the associated combustion chambers 18a, 18b, 18c, 18d, 18e, and 18f at predetermined timings, fuel pressures, and fuel flow rates.

The cylinder cutout system 14 includes an engine control module (ECM) 26 and a plurality of electronic components. The electronic components may include various sensors such as a crank position sensor 28, a load sensor 30, a coolant temperature sensor 32, and an electronic timer 34.

The ECM 26 is in control communication with the control solenoids 24a, 24b, 24c, 24e, and 24f, the crank position sensor 28, the load sensor 30, a coolant temperature sensor 32, and an electronic timer 34. The ECM 26 may include a multitude of programs to receive data from the above-mentioned components, process the data according to an algorithm interpreting the data using multidimensional performance maps, and output a result or a command. In the exemplary embodiment, the ECM 26 is functional to activate and de-activate a cylinder cutout strategy. The ECM 26 may be fed with one or more cylinder cutout strategies.

Each of the cylinder cutout strategies includes a first cutout pattern and a second cutout pattern. The ECM 26 is programmed to alternate the cylinder cutout strategy between the first cutout pattern and the second cutout pattern, under specific conditions. The first cutout pattern is associated with a first set of cylinders out of the cylinders 16a, 16b, 16c, 16d, 16e, and 16f. This implies that when the ECM 26 signals to activate the first cutout pattern, the first set of cylinders is cutout of fuel supply. The second cutout pattern is associated with a second set of cylinders out of the cylinders 16a, 16b, 16c, 16d, 16e, and 16f. This implies that when the ECM 26 signal to activate the second cutout pattern, the second set of cylinders is cutout of fuel supply. It may be noted that the first set of cylinders are different from the second set of cylinders in the cylinder cutout strategy.

The crank position sensor 28 is provided at a location near the crankshaft (not shown) of the engine 12. The crank position sensor 28 is operable to monitor a crank angle of the crankshaft (not shown) and a current engine speed. The crank position sensor 28 generates a crank position signal, on the basis of which the crank angle and the current engine speed are determined. A current degree of rotation is determined based on the crank angle. The crank position sensor 28 sends the crank position signal to the ECM 26.

The load sensor 30, commonly used, may be a throttle position sensor (TPS) or a manifold absolute pressure sensor (MAP) or any such other means to sense a current engine load. The load sensor 30 generates a load signal related a current engine load. The load signal is then communicated to the ECM 26.

The coolant temperature sensor 32 may be located in coolant passages (not shown) of the engine 12. The coolant temperature sensor 32 senses a temperature of coolant (not shown) circulating in the engine 12. The coolant temperature sensor 32 may be a resistor in contact with the coolant. Resistance of the coolant temperature sensor 32 changes in accordance with a change in temperature of the coolant temperature sensor 32. The coolant temperature sensor 32 generates a coolant temperature signal based on the coolant temperature measured. The coolant temperature sensor 32 communicates the coolant temperature signal to the ECM 26.

The electronic timer 34 is associated with the engine 12. The electronic timer 34 measures an actual length of time of operation of the engine 12, that is, a current run time of the engine 12. The electronic timer 34 generates an engine run time signal related to the current run time of the engine 12. The electronic timer 34 communicates the engine run time signal to the ECM 26.

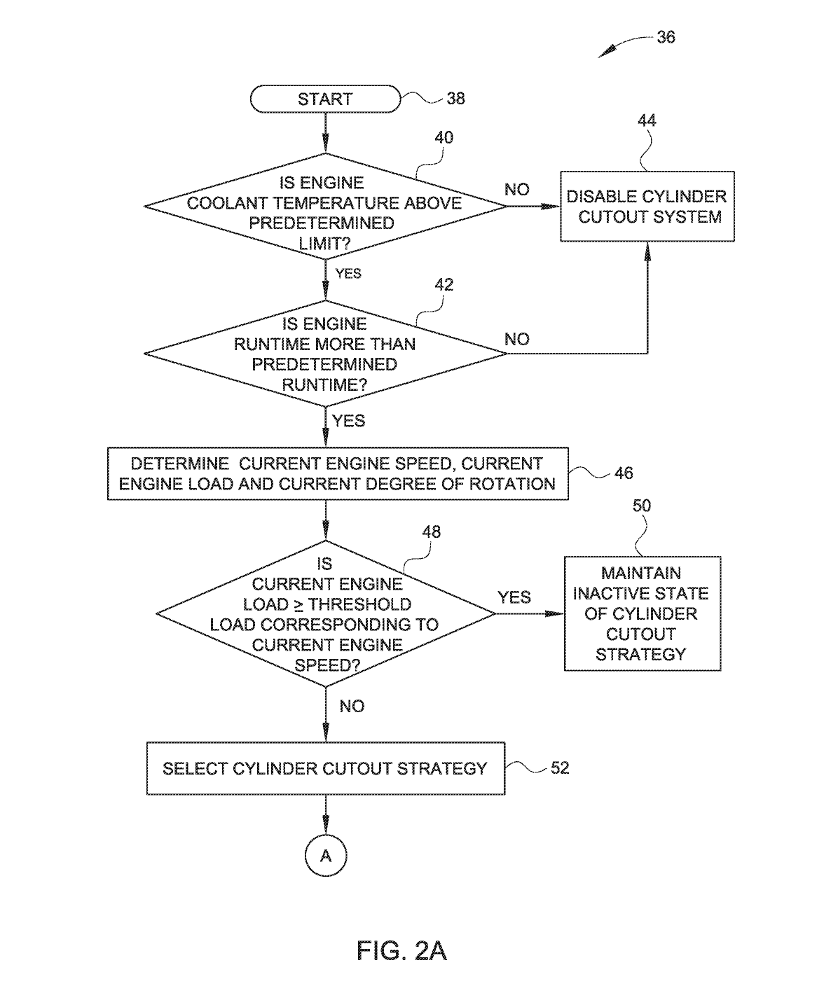

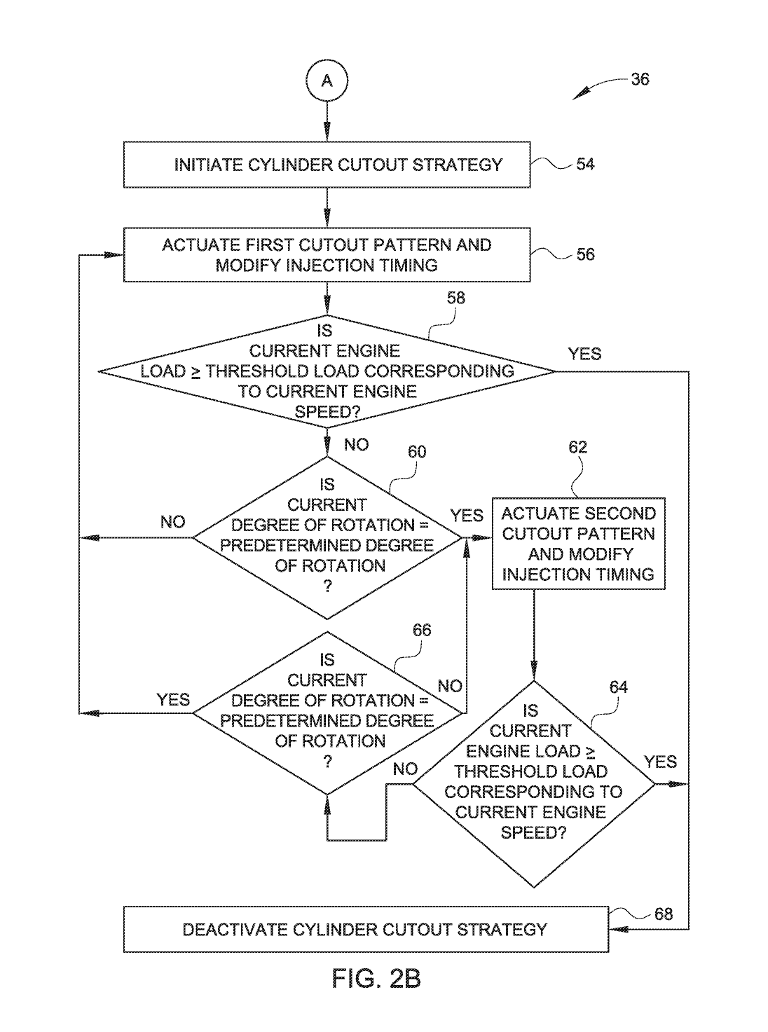

Referring to FIG. 2A-2B, there is shown a flow chart 36 of the cylinder cutout strategy. The method initiates at step 38.

At step 38, the ECM 26 determines operational parameters of the engine 12. The operational parameters include the servicing condition, the current run time of the engine 12, the coolant temperature, working condition of the fuel injectors 20a, 20b, 20c, 20d, 20e, and 20f, and an aftercooler temperature. The ECM 26 receives the engine run time signal via the electronic timer 34 and hence, the ECM 26 determines the current run time of the engine 12. The ECM 26 receives the coolant temperature signal from the coolant temperature sensor 32, and determines a current engine temperature based on the coolant temperature signal. The method proceeds to step 40.

At step 40, the ECM 26 monitors whether the operational parameters of the engine 12 are in accordance with enablement conditions. The ECM 26 compares the current engine temperature to a predetermined limit of a warm temperature mode. If the current engine temperature is above the predetermined limit, then the method proceeds to step 42, otherwise, the method proceeds to step 44.

At step 42, the ECM 26 monitors whether the operational parameters of the engine 12 are in accordance with enablement conditions. The ECM 26 compares the current run time to a predetermined runtime. If the current run time is above the predetermined runtime, then the method proceeds to step 46, otherwise, the method proceeds to step 44.

At step 44, when the ECM 26 receives signals that the operational parameters are not optimum, the ECM 26 disables the cylinder cutout system 14. By disabling the cylinder cutout mode, the ECM 26 will maintain normal fuel injection to the cylinders 16a, 16b, 16c, 16d, 16e, and 16f.

At step 46, the ECM 26 receives the crank position signal and the load signal, via the crank position sensor 28 and the load sensor 30, respectively. The ECM 26 determines the current engine speed based the crank position signal. In addition, the ECM 26 determines the current engine load based on the received load signal. The ECM 26 also calculates the current degree of rotation based on the crank angle, derived via the crank position signal. The method proceeds to step 48.

At step 48, the ECM 26 compares the current engine load to a threshold load corresponding to the current engine speed. The ECM 26 determines whether the current engine load is less than or equal to the threshold load. If the current engine load is greater than or equal to the threshold load, the method proceeds to step 50. If the current engine load is less than to the threshold load, then the method proceeds to step 52.

At step 50, the ECM 26 sends signals to maintain an inactive state of the cylinder cutout strategy.

At step 52, the ECM 26 selects one of the cylinder cutout strategies depending upon the current engine running conditions and the preceding cylinder cutout strategy. Upon selection of an optimum cylinder cutout strategy, the method proceeds to step 54.

At step 54, the ECM 26 initiates the cylinder cutout strategy. Upon initiation, the ECM 26 determines selection of one of the first cutout pattern and the second cutout pattern. After initiation, the method proceeds to step 56.

At step 56, in the exemplary embodiment, the ECM 26 sends signals to initiate the first cutout pattern. When the first cutout pattern is actuated, the first set of cylinders acts as a set of cutout cylinders, and the second set of cylinders acts as a set of non-cutout cylinders. Upon actuation of the first cutout pattern, the ECM 26 simultaneously signals the respective solenoids to modify injection timing of the fuel injectors 20a, 20b, 20c, 20d, 20e, and 20f. This implies that the ECM 26 sends electrical signals to the respective solenoids for the second set of cylinders, to energize them. The fuel injectors of the second set of cylinders inject fuel during an energized state of the respective solenoids. The ECM 26 controls the amount of fuel that is injected by varying the electrical signals which are sent to the injectors of the second set of cylinders. The amount of fuel is increased to the second set of cylinders, that is, the set of non-cutout cylinders, by a predetermined amount to maintain a uniform delivery of the fuel and thus, reducing a hunting behavior in the initial phase of fuel injection. In addition, the ECM 26 signals the injectors of the first set of cylinders to stop the fuel injection, and hence cut out. Upon actuation of the first cutout pattern, the first set of cylinders start deactivating one by one after a predetermined time interval therebetween, which may be a few seconds. The method proceeds to step 58.

At step 58, the ECM 26 compares the current engine load to the threshold load corresponding to the current engine speed. If the current engine load is lesser than the threshold load at the current engine speed, the method proceeds to step 60. If the current engine load is greater than or equal to the threshold load at the current engine speed, the method proceeds to step 68.

At step 60, the ECM 26 receives the crank position signal via the crank position sensor 28 and determines the current degree of rotation of the crankshaft (not shown). The ECM 26 receives a predetermined degree of rotation. The predetermined degree of rotation may be any value between 0 and 720 degree. Further, the ECM 26 compares the current degree of rotation of the crankshaft (not shown) to the predetermined degree of rotation. If the current degree of rotation of the crankshaft (not shown) is equal to the predetermined degree of rotation, the method proceeds to step 62, otherwise the method goes to step 56.

At step 62, the ECM 26 alternates the cylinder cutout strategy to the second cutout pattern. In the exemplary embodiment, the ECM 26 sends signals to initiate the second cutout pattern. When the second cutout pattern is actuated, the first set of cylinders acts as the set of non-cutout cylinders, and the second set of cylinders acts as the set of cutout cylinders. Upon actuation of the second cutout pattern, the ECM 26 simultaneously signals the respective solenoids to modify injection tuning of the fuel injectors 20a, 20b, 20c, 20d, 20e, and 20f. This implies that the ECM 26 sends electrical signals to the respective solenoids for the first set of cylinders, to energize them. The fuel injectors of the first set of cylinders inject fuel during an energized state of the respective solenoids. The ECM 26 controls the amount of fuel that is injected by varying the electrical signals which are sent to the injectors of the first set of cylinders. The amount of fuel is increased to the first set of cylinders, that is, the set of non-cutout cylinders, by the predetermined amount to maintain the uniform delivery of the fuel and thus, reducing a hunting behavior in the initial phase of fuel injection. In addition, the ECM 26 signals the injectors of the second set of cylinders to stop the fuel injection, and hence cut out. Upon actuation of the second cutout pattern, the second set of cylinders start deactivating one by one after the predetermined time interval therebetween, which may be a few seconds. The method proceeds to step 64.

At step 64, the ECM 26 compares the current engine load to the threshold load corresponding to the current engine speed. If the current engine load is lesser than the threshold load at the current engine speed, the method proceeds to step 66. If the current engine load is greater than or equal to the threshold load at the current engine speed, the method proceeds to step 68.

At step 66, the ECM 26 receives the crank position signal via the crank position sensor 28 and determines the current degree of rotation of the crankshaft (not shown). Further, the ECM 26 compares the current degree of rotation of the crankshaft (not shown) to the predetermined degree of rotation. If the current degree of rotation of the crankshaft (not shown) is equal to the predetermined degree of rotation, the method proceeds to step 56, otherwise the method goes to step 62.

At step 68, upon sensing that the current engine load is greater than or equal to the threshold load that corresponds to the current engine speed, the ECM 26 determines that there is no requirement of the cylinder cutout strategy. Hence, the ECM 26 deactivates the cylinder cutout strategy. Upon deactivation of the cylinder cutout strategy, the ECM 26 restores the injection timing of the fuel injectors 20a, 20b, 20c, 20d, 20e, and 20f, such that the cylinders 16a, 16b, 16c, 16d, 16e, and 16f are actuated to restore normal operation.

### INDUSTRIAL APPLICABILITY

In operation, the ECM 26 receives sensor data from the coolant temperature sensor 32 and the electronic timer 34, in real time. Based on this, the ECM 26 determines that the engine 12 is running at optimum engine temperature for an optimum amount of time. Thereafter, the ECM 26 checks for the current engine speed and the current engine load, via the crank position sensor 28 and the load sensor 30, respectively. Upon determination that the current engine load is lesser than the threshold load that corresponds to the current engine speed, the ECM 26 selects an optimum cylinder cutout strategy out of the available cylinder cutout strategies. The optimum cylinder cutout strategy is dependent on conditions like the current engine load and the current engine speed. As an example, for the selected cylinder cutout strategy, the first cutout pattern includes the first set of cylinders 16a, 16c, and 16e, and the second cutout pattern includes the second set of cylinders 16b, 16d, and 16f. When the first cutout pattern is initiated, the ECM 26 sends signals to the control solenoids 24a to terminate fuel injection via the fuel injectors 20a, thereby cutting out the cylinder 16a. After a few seconds, the ECM 26 signals the control solenoid 24c to terminate fuel injection via the fuel injector 20c, thereby cutting out the cylinder 16c, while the cylinder 16a is still cut out. The ECM 26, then signals the control solenoid 24e to terminate fuel injection via the fuel injector 20e, thereby cutting out the cylinder 16e, while the cylinders 16a and 16c are still cut out. The first cutout pattern is now completed on reaching the cutout for all the cylinders 16a, 16c, and 16e of the first cutout pattern. While the cylinders 16a, 16c, and 16e are cut out, the ECM 26 also modifies the injection timing of operating cylinders 16b, 16d, and 16f. The ECM 26 signals the control solenoids 24b, 24d, and 24f to increase the injection timing of the fuel injectors 20b, 20d, and 20f, during the first cutout pattern. The amount of fuel is increased to the second set of cylinders 16b, 16d, and 16f (a set of non-cutout cylinders) by the predetermined amount, to compensate for the loss of the first set of cylinders 16a, 16c, and 16e (a set of cutout cylinders) and also to allow stable engine operation owing to fuel supply rate in stable region of a fuel supply curve. The ECM 26 determines the current degree of rotation based on the crank position signal, via the crank position sensor 28. The cylinders 16a, 16c, and 16e continue to be cut out, until the ECM 26 determines that the current degree of rotation is equal to the predetermined degree of rotation. Upon detection of the current degree of rotation as the predetermined degree of rotation, the ECM 26 switches the cylinder cutout strategy to the second cutout pattern. When the second cutout pattern is initiated, the ECM 26 send signals to the control solenoids 24b, 24d, and 24f to altogether terminate the fuel injection of the fuel injectors 20b, 20d, and 20f, respectively. This results in cutting out of the cylinders 16b, 16d, and 16f. When switching to the second cutout pattern, all the cylinders 16b, 16d, and 16f are cut together, as the first cutout patterns adapts engine 12 to run at half the operating cylinders during the cylinder cutout strategy. While the cylinders 16b, 16d, and 16f are cut out, the ECM 26 also modifies the injection timing of operating cylinders 16a, 16c, and 16e. The ECM 26 signals the control solenoids 24a, 24c, and 24e to increase the injection timing of the fuel injectors 20a, 20c, and 20e, during the second cutout pattern. The ECM 26 re-determines that the current degree of rotation and alternates between the cutout patterns on completion of every predetermined degree of rotation. This cylinder cutout strategy continues to operate until the engine 12 starts to run at the current engine load greater than the threshold load corresponding to the current engine speed.

As another example, the ECM 26 may select an asymmetric cylinder cutout strategy as an optimum cylinder cutout strategy. For the asymmetric cylinder cutout strategy, the first cutout pattern includes the first set of cylinders 16c and 16f, and the second cutout pattern includes the second set of cylinders 16a, 16b, 16d, and 16e. When the first cutout pattern is initiated, the ECM 26 sends signals to the control solenoids 24c and 24f to terminate fuel injection via the fuel injectors 20c and 20f, thereby cutting out the cylinders 16c and 16f. While the cylinders 16c and 16f are cut out, the ECM 26 also modifies the injection timing of operating cylinders 16a, 16b, 16d, and 16e. The ECM 26 signals the control solenoids 24a, 24b, 24d, and 24e to increase the injection timing of the fuel injectors 20a, 20b, 20d, and 20e, during the first cutout pattern. The amount of fuel is increased to the second set of cylinders 16a, 16b, 16d, and 16e by the predetermined amount to maintain the uniform delivery of the fuel. The ECM 26 determines the current degree of rotation based on the crank position signal, via the crank position sensor 28. The cylinders 16c, and 16f continue to be cut out, until the ECM 26 determines that the current degree of rotation is equal to the predetermined degree of rotation. Upon detection of the current degree of rotation as the predetermined degree of rotation, the ECM 26 switches from the first cutout pattern to the second cutout pattern. The ECM 26 send signals to the control solenoids 24a, 24b, 24d, and 24e to altogether terminate the fuel injection of the fuel injectors 20a, 20b, 20d, and 20e, respectively. This results in cutting out of the cylinders 16a, 16b, 16d, and 16e. While the cylinders 16a, 16b, 16d, and 16e are cut out, the ECM 26 also modifies the injection timing of operating cylinders 16c and 16f. The ECM 26 signals the control solenoids 24c and 24f to increase the injection timing of the fuel injectors 20c and 20f, during the second cutout pattern. The ECM 26 re-determines that the current degree of rotation and alternates between the cutout patterns on detection of every predetermined degree of rotation. This cylinder cutout strategy continues to operate until the engine 12 starts to run at the current engine load greater than the threshold load corresponding to the current engine speed. The fuel injection to the set of non-cutout cylinders is continually modified until the deactivation of the cylinder cutout strategy.

The disclosed method to stabilize the engine is advantageous, as the initialization is done by cutting one cylinder at a time in the order of the selected cutout pattern. The initialization ensures that the engine 12 does not suffer sudden decrease in speed which may cause instability. The initialization is followed by the tuneable cylinder cutout strategy. The tuneable cylinder cutout strategy provides a provision to select the most suitable cylinder cutout strategy from the available cylinder cutout strategy being fed to the ECM 26. This also increases the available cutout patterns over which the engine 12 can be operated to achieve a linear fuel delivery curve. The cutout patterns are determined in a way to focus on factors related to uniform heating of the cylinders 16a, 16b, 16c, 16d, 16e, and 16f and torsional balance of the crankshaft (not shown). Since, the tuneable cylinder cutout strategy ensures the uniform heating of the cylinders 16a, 16b, 16c, 16d, 16e, and 16f, thus, uneven wear of the cylinders 16a, 16b, 16c, 16d, 16e, and 16f is minimised. The tuneable cylinder cutout strategy also ensures torsional balance of the crankshaft (not shown), thus, the damages due to vibrations are minimised. This results in prolonged life of components of the engine 12. Further, the tuneable cylinder cutout strategy allows the set of non-cutout cylinders to deliver fuel in a more linear portion of an injector delivery curve, reducing a hunting behavior and speed oscillation seen from operating in a nonlinear zone.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A method of operation of an engine, the method comprising:
determining a current engine speed, a current engine load, and a coolant temperature via an engine control module;
determining a current degree of rotation measured via a crank position sensor;
determining a cylinder cutout strategy from a plurality of cylinder cutout strategies upon determining that the current engine load is below a threshold load corresponding to the current engine speed, wherein the cylinder cutout strategy comprises using a first set of cylinders and a second set of cylinders in an alternating manner, wherein the second set of cylinders is different from the first set of cylinders;
initiating the cylinder cutout strategy wherein fuel supply is cutout alternatively between the first set of cylinders and the second set of cylinders, upon detection that the current degree of rotation corresponds to a predetermined degree of rotation;
modifying fuel injection timing in the plurality of cylinders, wherein a set of non-cutout cylinders from the plurality of cylinders, is configured to receive a predetermined amount of fuel upon completion of the predetermined degree of rotation to facilitate a stable operation of the engine; and
deactivating the cylinder cutout strategy when the current engine load exceeds the threshold load corresponding to the current engine speed.
